(19) United States
(12) Patent Application Publication
(10) Pub. No.: US 2008/0074905 A1
(43) Pub. Date: Mar. 27, 2008

(54) Method for Controlling Bidirectional DC-DC Converter

(75) Inventors: Sergey Moiseev, Kariya-shi (JP); Nobuo Hirabayashi, Kariya-shi (JP)

Correspondence Address: WOODCOCK WASHBURN LLP, CIRA CENTRE, 12TH FLOOR, 2929 ARCH STREET, PHILADELPHIA, PA, 19104-2891, US

(73) Assignee: Kabushiki Kaisha Toyota Jidoshokki, Kariya-shi (JP)

(21) Appl. No.: 11/858,956

(22) Filed: Sep. 21, 2007

(30) Foreign Application Priority Data
Sep. 22, 2006 (JP) 2006-257229

(51) Int. Cl. H02M 3/335

(52) U.S. Cl. 363/20

(57) ABSTRACT

A method for controlling a bidirectional DC-DC converter that reduces switching loss during a step-down operation and conduction loss caused by synchronous rectification, while enabling bidirectional operation with the same control. The DC-DC converter includes first and second switch elements for alternately applying voltage in opposite directions to a transformer winding during the step-down operation and performing synchronous rectification during a step-up operation. Third and fourth switch elements perform synchronous rectification during the step-down operation and alternately apply voltage in opposite directions to the transformer in the step-up operation. The method includes activating the first switch when the third switch is in an active state, activating the second switch when the fourth switch is in an active state, switching each of the third and forth switches between an active state and an inactive state while inactivating the third or fourth switch.

### CROSS-REFERENCE TO RELATED APPLICATIONS

This application is based upon and claims the benefit of priority from the prior Japanese Patent Application No. 2006-257229, filed on Sep. 22, 2006, the entire contents of which are incorporated herein by reference.

### FIELD OF THE INVENTION

The present invention relates to a method for controlling a bidirectional DC-DC converter, and more particularly, to a method for controlling a bidirectional DC-DC converter capable of reducing switching loss and conduction loss through execution of a simple switching control.

### BACKGROUND OF THE INVENTION

“Bidirectional DC-DC Converter for Super Capacitor-Based Energy Storage Systems” by Tomokazu Mishima et al., The Institute of Electronics, Information and Communication Engineers Technical Report of IEICE, EE2005-35 (2005-9), P. 19-24 (hereinafter referred to as “non-patent document 1”) discloses a bidirectional DC-DC converter.

The bidirectional DC-DC converter disclosed in non-patent document 1 has a primary side configured by a half bridge converter, which is formed by a MOSFET, and a secondary side configured by a current push-pull inverter. The DC-DC converter performs voltage adjustment with a constant voltage power supply such as a battery that functions as a main power supply E1 at the high voltage primary side, and a variable voltage source such as a super capacitor arranged at the low voltage secondary side and having terminal voltage that varies in accordance with the stored energy amount.

Non-patent document 1 considers the application of a bidirectional DC-DC converter to an auxiliary power supply for an electric vehicle (EV) or the like. In this case, a capacitor charging operation is performed to mainly regenerate energy for the main power supply E1 and absorb surplus power. Thus, the capacitor charging operation requires an increased energy transmission efficiency rather than a quick response.

Accordingly, when charging the capacitor, each switch element of the half bridge and push-pull circuits always operates at a constant maximum duty (about 50%). The capacitor voltage rises at a rate determined by a time constant resulting from an inductance value of the secondary side coil and a capacitance value of the capacitor. When the capacitor performs a discharging operation, the voltage applied to the primary side power supply E1 is adjusted by adjusting the overlapping ON-time of the plurality of switches in the push-pull circuit in accordance with the capacitor voltage.

Non-patent document 1 describes controlling of the switch elements in the half bridge circuit so that the maximum duty becomes 50% when charging the capacitor. Thus, in the bidirectional DC-DC converter of non-patent document 1, the activation time for two switch elements in the half bridge circuit are set to be the same, and PWM control is executed so that the switch elements are alternately activated.

In non-patent document 1, the switching duty when each switch element of the half bridge circuit is controlled is fixed at the maximum duty of 50%. This minimizes the dead time between the two switch elements. However, the two switch elements may be controlled at a switching duty that differs from 50% depending on the voltage condition of the primary side power supply E1 and the secondary side super capacitor. This may prolong the duration of the dead time.

During the duration of the dead time, current flowing due to the activation of the switch elements in the push-pull circuit continues to flow through an antiparallel diode. When the current flows through the antiparallel diode, the conduction loss increases as compared to when the current flows to the switch elements.

Since the duration of the dead time varies in accordance with the voltage conditions, the control of a soft switching operation cannot be performed at a predetermined timing. Thus, a hard switching operation must be performed for the switch elements of the half bridge circuit. Therefore, switching loss cannot be reduced.

### SUMMARY OF THE INVENTION

It is an object of the present invention to provide a method for controlling a bidirectional DC-DC converter capable of reducing switching loss during a step-down operation and reducing conduction loss during synchronous rectification, while enabling bidirectional operation with the same control.

One aspect of the present invention relates to a method for controlling a bidirectional DC-DC converter for selectively performing a step-down operation and a step-up operation. The bidirectional DC-DC converter includes a transformer, which has a high-voltage side winding and a low-voltage side winding. Alternately activated first and second switch elements are connected to the high-voltage side winding in order to alternately apply high voltage in opposite directions to the high-voltage side winding during the step-down operation and full-wave rectify current that is output from the high-voltage side winding by performing synchronous rectification during the step-up operation. First and second antiparallel diodes are respectively connected to the first and second switch elements. First and second capacitors are respectively connected in parallel to the first and second switch elements. Third and fourth switch elements are connected to the low-voltage side winding and activated in accordance with the active state of the first and second switch elements for full-wave rectifying current that is output from the low-voltage side winding by performing synchronous rectification during the step-down operation and alternately applying low voltage in opposite directions to the low-voltage side winding during the step-up operation. Third and fourth antiparallel diodes are respectively connected to the third and fourth switch elements. An inductance element is arranged in a path extending from the low-voltage side winding to the low voltage. The method includes activating the third switch element, activating the first switch element when the third switch element is in an active state, activating the fourth switch element, activating the second switch element when the third switch element is in an active state, and switching each of the third and fourth switch elements between an active state and an inactive state while inactivating the first and second switch elements for a predetermined time and activating at least one of the third and the fourth switch elements.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic circuit diagram showing a bidirectional DC-DC converter according to a preferred embodiment of the present invention;

FIG. 2 is a timing chart showing a switching control of the bidirectional DC-DC converter of FIG. 1;

FIG. 3 is a circuit diagram of the bidirectional DC-DC converter in switching state (1) during a step-down operation;

FIG. 4 is a circuit diagram of the bidirectional DC-DC converter in switching state (2) during the step-down operation;

FIG. 5 is a circuit diagram of the bidirectional DC-DC converter in switching state (3) during the step-down operation;

FIG. 6 is a circuit diagram of the bidirectional DC-DC converter in switching state (4) during the step-down operation;

FIG. 7 is a circuit diagram of the bidirectional DC-DC converter in switching state (5) during the step-down operation;

FIG. 8 is a circuit diagram of the bidirectional DC-DC converter in switching state (6) during the step-down operation;

FIG. 9 is a circuit diagram of the bidirectional DC-DC converter in switching state (7) during the step-down operation;

FIG. 10 is a circuit diagram of the bidirectional DC-DC converter in switching state (8) during the step-down operation;

FIG. 11 is a timing chart showing the operation of a MOS transistor during a dead time period;

FIG. 12 is a circuit diagram of the bidirectional DC-DC converter in switching states (8), (1), and (2) during a step-up operation;

FIG. 13 is a circuit diagram of the bidirectional DC-DC converter in switching states (3) and (4) during the step-up operation;

FIG. 14 is a circuit diagram of the bidirectional DC-DC converter in switching states (5) and (6) during the step-up operation;

FIG. 15 is a circuit diagram of the bidirectional DC-DC converter in switching states (7) and (8) during the step-up operation;

FIG. 16 is a schematic circuit diagram of a bidirectional DC-DC converter according to a further example of the present invention that includes a boost half bridge circuit;

FIG. 17 is a schematic circuit diagram of a bidirectional DC-DC converter according to another example of the present invention that includes an active clamp forward circuit; and

FIG. 18 is a schematic circuit diagram of a bidirectional DC-DC converter according to still another example of the present invention that includes an active clamp forward circuit and a current doubler rectification circuit.

### DETAILED DESCRIPTION OF ILLUSTRATIVE EMBODIMENTS

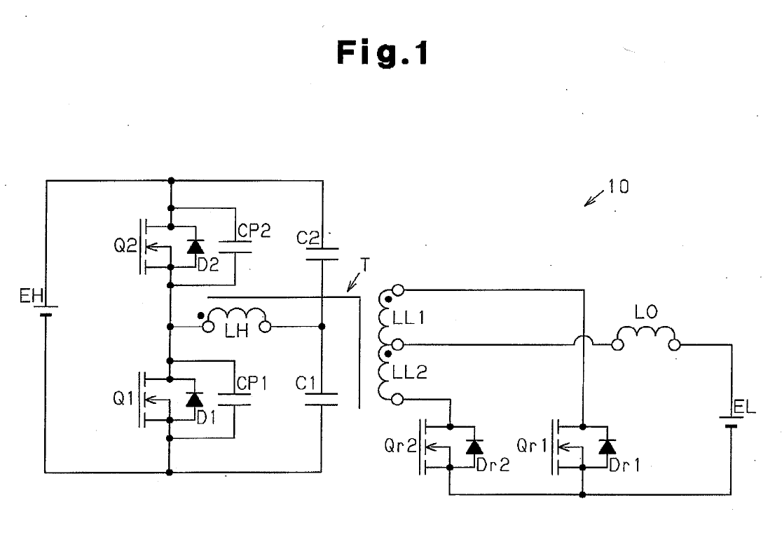

A method for controlling a bidirectional DC-DC converter 10 according to a preferred embodiment of the present invention will now be described in detail with reference to FIGS. 1 to 18.

FIG. 1 is a schematic circuit diagram of the bidirectional DC-DC converter 10. The illustrated bidirectional DC-DC converter 10 enables bidirectional power transmission. In other words, the DC-DC converter 10 selectively executes a step-down operation for transmitting power from a high voltage EH to a low voltage EL via a transformer T and a step-up operation for transmitting power from the low voltage EL to the high voltage EH via the transformer T.

The bidirectional DC-DC converter 10 has the following configuration. A reference terminal (terminal marked by black dot in FIG. 1) of a high-voltage side winding LH of the transformer T is connected to a drain terminal of a MOS transistor Q1 and a source terminal of a MOS transistor Q2. A non-reference terminal of the high-voltage side winding LH is connected to one terminal of a capacitor C1 and one terminal of a capacitor C2.

The source terminal of the MOS transistor Q1 and the other terminal of the capacitor C1 are both connected to a negative pole of the high voltage EH, and the drain terminal of the MOS transistor Q2 and the other terminal of the capacitor C2 are both connected to a positive pole of the high voltage EH.

The MOS transistors Q1 and Q2 respectively include antiparallel diodes D1 and D2. Furthermore, capacitors CP1 and CP2 are connected in parallel to the MOS transistors Q1 and Q2, respectively.

The low voltage EL side of the transformer T includes two low voltage side windings LL1 and LL2 with an intermediate tap in between. The intermediate tap connects a reference terminal (terminal marked by black dot in FIG. 1) of the low-voltage side winding LL2 and a non-reference terminal of the low-voltage side winding LL1. The intermediate tap is connected to one end of an inductance element LO, and the other end of the inductance element LO is connected to a positive pole of the low voltage EL. The reference terminal of the low-voltage side winding LL1 and the non-reference terminal of the low-voltage side winding LL2 are respectively connected to the drains of MOS transistors Qr1 and Qr2. The source terminals of the MOS transistors Qr1 and Qr2 are connected to the negative pole of the low voltage EL. The MOS transistors Qr1 and Qr2 respectively include antiparallel diode Dr1 and Dr2.

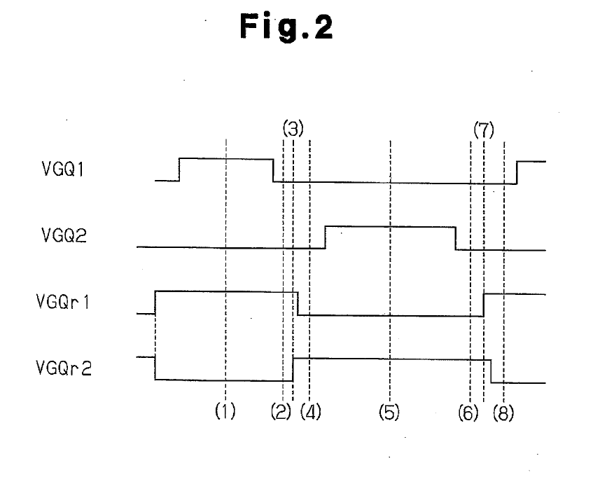

FIG. 2 is a timing chart of a switching control for the MOS transistors Q1, Q2, Qr1, and Qr2 when the step-down operation and/or step-up operation are performed in the bidirectional DC-DC converter of FIG. 1.

In the preferred embodiment, the bidirectional DC-DC converter 10 is capable of performing both the step-down operation and the step-up operation with the same switching control. In such switching control, eight switching states (1) to (8), which are described below, are sequentially repeated.

In switching state (1), the gate voltage VGQ1 of the MOS transistor Q1 and the gate voltage VGQr1 of the MOS transistor Qr1 are set to a high level. Therefore, the MOS transistors Q1 and Qr1 are both activated.

In switching state (2), the gate voltage VGQ1 of the MOS transistor Q1 is set to a low level while the gate voltage VGQr1 of the MOS transistor Qr1 is maintained at a high level. That is, the MOS transistor Q1 is inactivated while the MOS transistor Qr1 remains activated.

In switching state (3), the gate voltage VGQr2 of the MOS transistor Qr2 is set to a high level while the gate voltage VGQr1 of the MOS transistor Qr1 is maintained at a high level. That is, the MOS transistor Qr2 is activated while the MOS transistor Qr1 remains activated.

In switching state (4), the gate voltage VGQr1 of the MOS transistor Qr1 is set to a low level while the gate voltage VGQr2 of the MOS transistor Qr2 is maintained at a high level. In other words, the MOS transistor Qr1 is set inactivated while the MOS transistor Qr2 remains activated.

The duration of switching state (3) may be short so that switching state (2) quickly shifts to switching state (4). That is, the gate voltage VGQr2 of the MOS transistor Qr2 may shift to a high level at substantially the same time as when the gate voltage VGQr1 of the MOS transistor Qr1 shifts to a low level. In this case, the MOS transistor Qr2 is activated at substantially the same time as when the MOS transistor Qr1 is inactivated.

In switching state (5), the gate voltage VGQ2 of the MOS transistor Q2 and the gate voltage VGQr2 of the MOS transistor Qr2 are set to a high level. Therefore, the MOS transistors Q2 and Qr2 are both activated.

In switching state (6), the gate voltage VGQ2 of the MOS transistor Q2 is set to a low level while the gate voltage VGQr2 of the MOS transistor Qr2 is maintained at high level. That is, the MOS transistor Q2 is inactivated while the MOS transistor Qr2 remains activated.

In switching state (7), the gate voltage VGQr1 of the MOS transistor Qr1 is set to a high level while the gate voltage VGQr2 of the MOS transistor Qr2 is maintained at a high level. That is, the MOS transistor Qr1 is set to the activated while the MOS transistor Qr2 remains activated.

In switching state (8), the gate voltage VGQr2 of the MOS transistor Qr2 is set to a low level while the gate voltage VGQr1 of the MOS transistor Qr1 is maintained at a high level. That is, the MOS transistor Qr2 is set inactivated while the MOS transistor Qr1 remains activated.

The duration of switching state (7) may be short so that switching state (6) quickly shifts to switching state (8). That is, the gate voltage VGQr1 of the MOS transistor Qr1 may shift to a high level at substantially the same time as the timing at which the gate voltage VGQr2 of the MOS transistor Qr2 shifts to a low level. In this case, the MOS transistor Qr1 shifts to the active state at substantially the same time as when the MOS transistor Qr2 shifts to the inactive state.

In the switching control of FIG. 2, the dead time at which both MOS transistors Q1 and Q2 are inactivated is fixed to a predetermined time irrespective of the high voltage EH, the low voltage EL, and other operating conditions. An asymmetric PWM control is thus performed in the step-down operation. The dead time at which both MOS transistors Qr1 and Qr2 are in the inactivated is not provided when the MOS transistors Qr1 and Qr2 are shifted to the active state.

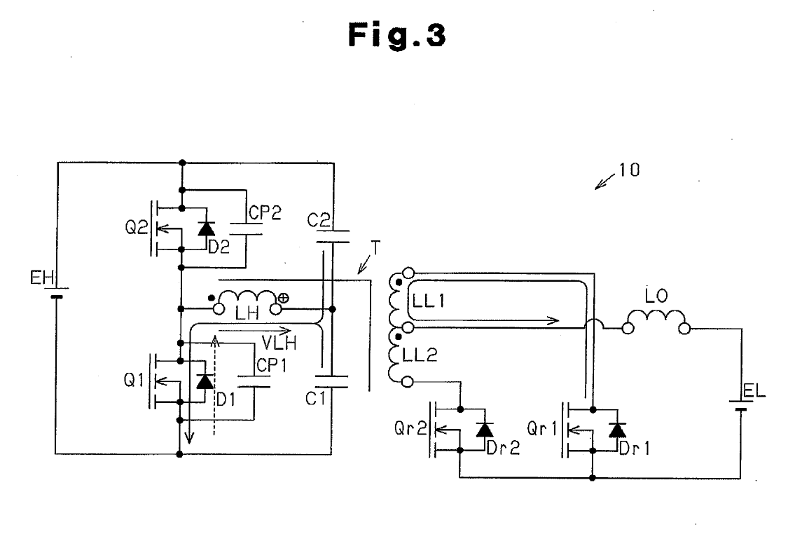

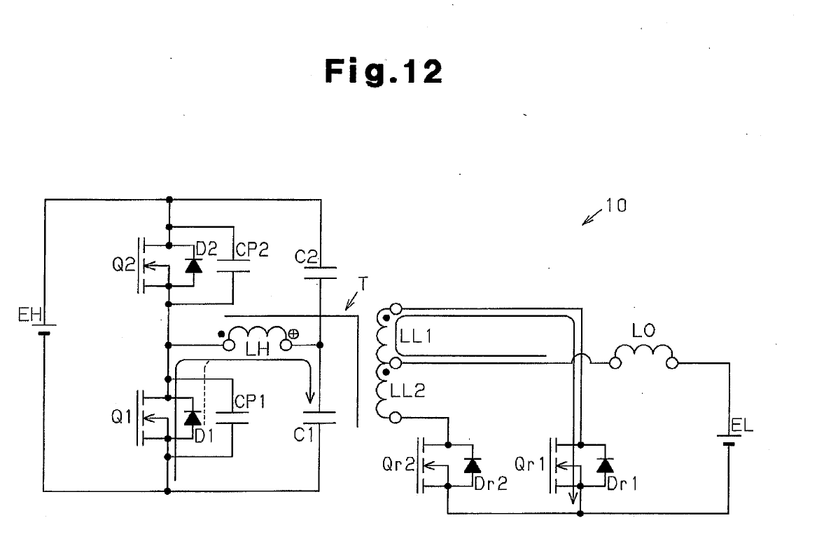

The bidirectional DC-DC converter 10 of FIG. 1 performs both the step-down operation and the step-up operation by executing the switching control of the switching states (1) to (8) described above. The step-down operation will be described with reference to FIGS. 3 to 11, and the step-up operation will be described with reference to FIGS. 12 to 15.

First, the step-down operation will be described. FIG. 3 shows switching state (1). The MOS transistor Q1 is active and current flows from the capacitors C1 and C2 to ground potential via the high-voltage side winding LH and the MOS transistor Q1. The high voltage is applied to the non-reference terminal of the high voltage side winding LH to start excitation of the transformer T. Current then flows from the non-reference terminal of the low-voltage side winding LL1 to the low voltage EL via the inductance element LO. In this state, the MOS transistor Qr1 is in the active state and functions as a synchronous rectification element.

In FIG. 3, current flowing from the ground potential to the MOS transistor Q1 (shown by broken line) is the current generated in the commutation operation of the transformer T in the previous cycle. The current flows from the non-reference terminal of the high-voltage side winding LH following the completion of the commutation operation by activating the MOS transistor Q1 prior to the completion of the commutation operation. This starts excitation of the transformer T.

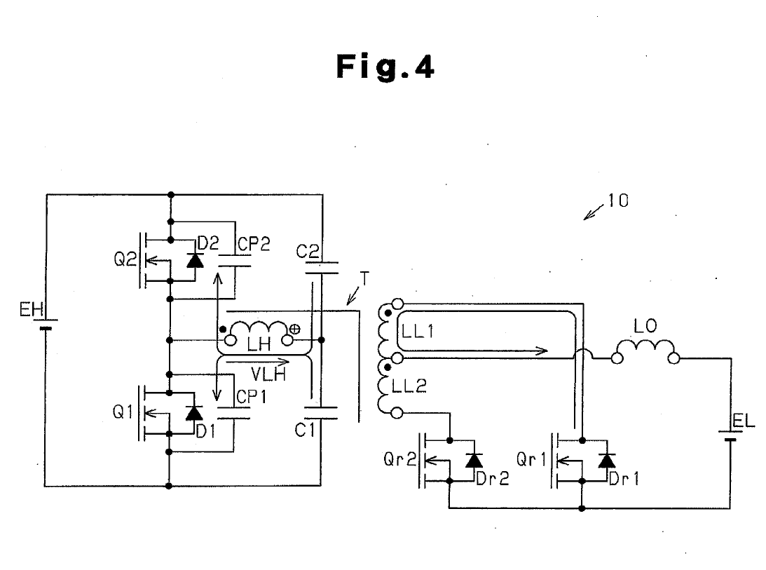

FIG. 4 shows switching state (2). Specifically, FIG. 4 shows a state immediately after the MOS transistor Q1 becomes inactive. When the MOS transistor Q1 becomes inactive state, charging of the capacitor CP1 and discharging of the capacitor CP2 are performed, and the voltage applied between the terminals of the high-voltage side winding LH decreases. Although the voltage between the terminals of the high-voltage side winding LH decreases, the bias relationship in switching state (1) (FIG. 3) remains the same as that in switching state (2). Thus, current continues to flow from the non-reference terminal of the low-voltage side winding LL1 to the low voltage EL via the inductance element LO. The MOS transistor Qr1 also functions as a synchronous rectification element.

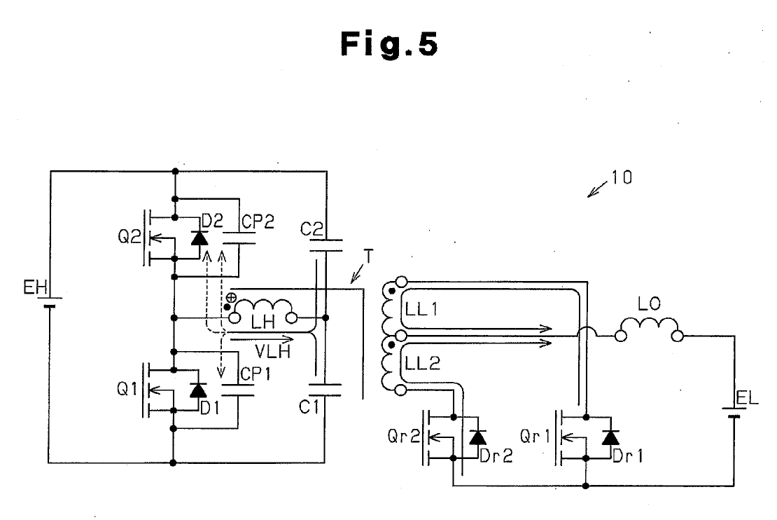

FIG. 5 shows switching state (3). The shifting from switching state (2) (FIG. 4) to switching state (3) is performed in the following manner. When the inter-terminal voltage of the high-voltage side winding LH decreases in switching state (2), the excitation voltage between the high-voltage side winding LH and the low-voltage side windings LL1 and LL2 becomes zero, and electromotive force caused by the leakage inductance component appears on the high-voltage side winding LH. Therefore, the reference terminal of the high-voltage side winding LH becomes a high voltage, and the current flowing to the high-voltage side winding LH is maintained. Excitation voltage does not appear at the low-voltage side windings LL1 and LL2, and the terminals of the windings LL1 and LL2 are short-circuited. As a result, the commutation operation by the transformer T starts.

After the commutation operation starts, the MOS transistor Qr2 becomes active state to shift to the switching state (3). The transformer T is still in the commutation operation period. Thus, electromotive force is not induced between the terminals of the low-voltage side windings LL1 and LL2. The output current that flows to the inductance element LO when the MOS transistors Qr1 and Qr2 are both active flows to the two low-voltage side windings LL1 and LL2. Thereafter, the current path sequentially switches from the low-voltage side winding LL1 to the low-voltage side winding LL2. In this case, the current path is switched such that the current flowing to the inductance element LO, which functions as an output coil, is continuous.

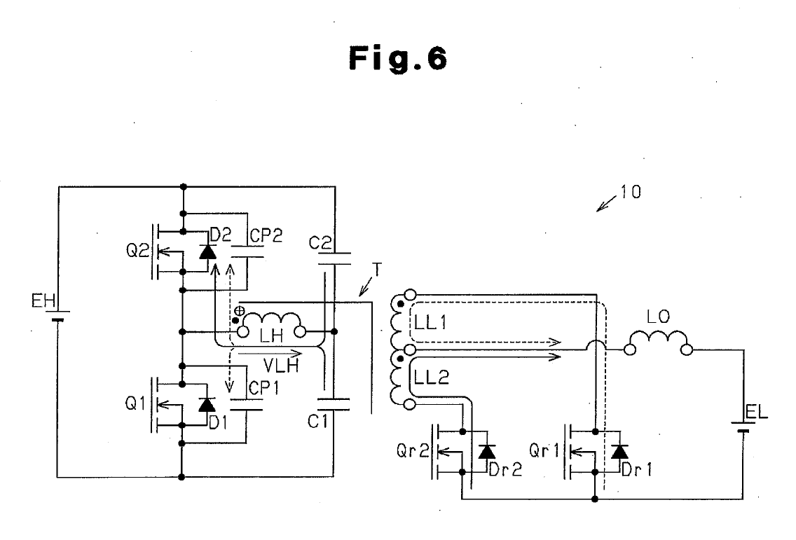

Subsequently, the operation shifts to switching state (4) in FIG. 6. Specifically, the MOS transistor Qr1 is inactivated while the commutation operation is being continuously performed and current still flows to the low-voltage side winding LL1. After the MOS transistors Qr1 becomes inactive, current continuously flows via the antiparallel diode Dr1 of the MOS transistors Qr1. At substantially the same time, the voltage at the reference terminal of the high-voltage side winding LH becomes high voltage so that current flows towards the high voltage EH via the antiparallel diode D2 of the MOS transistors Q2.

The transition timing to the inactive state of the MOS transistor Qr1 is preferably a period in which the commutation operation of the transistor T is being performed. Electromotive force is not induced between the terminals of the low-voltage side windings LL1 and LL2 during the commutation operation. Thus, the excitation voltage is induced when the commutation operation is completed. However, if the MOS transistor Qr1 is in the active state in addition to the MOS transistor Qr2 after the commutation operation is completed, current may flow to the low voltage EL due to the excitation voltage since the terminals of the low-voltage side windings LL1 and LL2 are in a short-circuited state.

The shifting of the MOS transistor Qr2 to the active state and the shifting of the MOS transistor Qr1 to the inactive state may occur at the same time as long as the commutation operation is being performed. This is because current flows via the antiparallel diodes Dr1 and Dr2 even if the MOS transistors Qr1 and Qr2 are inactive.

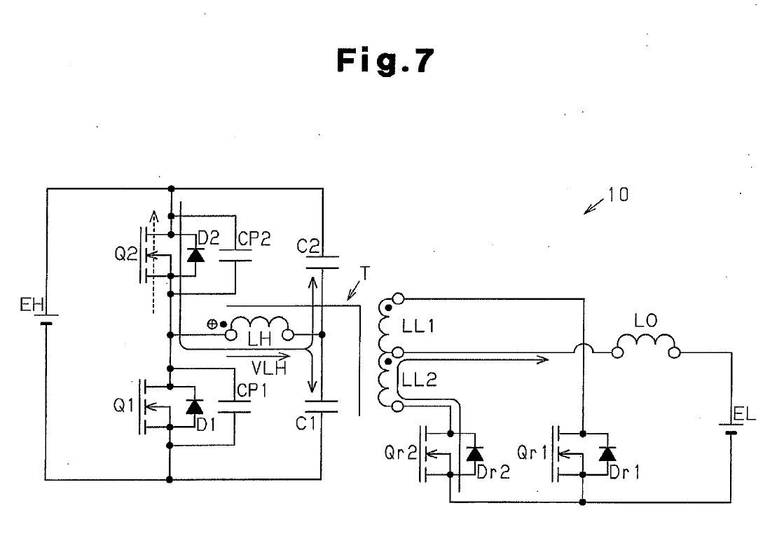

FIG. 7 shows switching state (5). The reference terminal of the high-voltage side winding LH reaches a high voltage in switching state (4) in which the MOS transistor Qr1 is in the inactive state, and the MOS transistor Q2 shifts to the active state while current flows towards the high voltage EH via the antiparallel diode D2 of the MOS transistor Q2.

Thereafter, current flows from the high voltage EH to the capacitors C1 and C2 via the MOS transistor Q2 and the high-voltage side winding LH. As a result, high voltage is applied to the reference terminal of the high-voltage side winding LH, and excitation starts in the opposite direction of the transformer T. Thus, current flows from the reference terminal of the low-voltage side winding LL2 to the low voltage EL via the inductance element LO. In this state, the MOS transistor Qr2 is in the active state and functions as a synchronous rectification element.

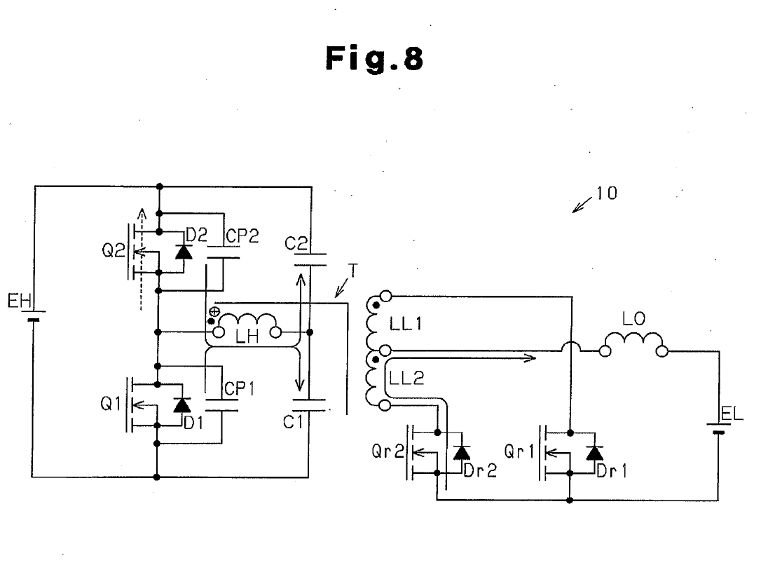

FIG. 8 shows switching state (6). This operation state corresponds to switching state (2) (FIG. 4). Specifically, FIG. 8 shows a state immediately after the MOS transistor Q2 becomes inactive. When the MOS transistor Q2 becomes inactive, discharging of the capacitor CP1 and charging of the capacitor CP2 are performed, and the voltage applied between the terminals of the high-voltage side winding LH decreases. Although the voltage between the terminal of the high-voltage side winding LH decreases, the bias relationship in switching state (6) remains the same as in switching state (5) (FIG. 7). Thus, current continues to flow from the reference terminal of the low-voltage side winding LL2 to the low voltage EL via the inductance element LO. The MOS transistor Qr2 also functions as a synchronous rectification element.

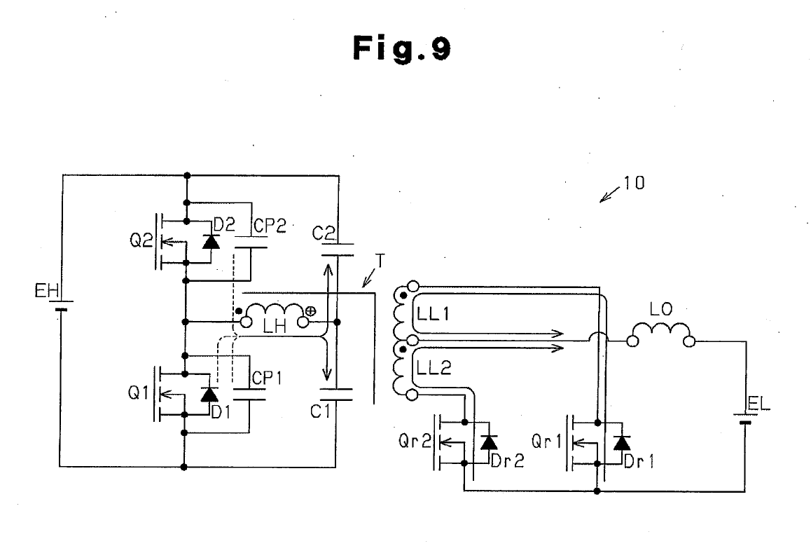

FIG. 9 shows switching state (7). This operation state corresponds to switching state (3) (FIG. 5). The shifting from switching state (6) (FIG. 8) to switching state (7) is performed in the following manner. When the voltage between the terminal of the high-voltage side winding LH decreases in switching state (6), the excitation voltage between the high-voltage side winding LH and the low-voltage side windings LL1 and LL2 becomes zero and electromotive force caused by the leakage inductance component appears on the high-voltage side winding LH. Therefore, the non-reference terminal of the high-voltage side winding LH becomes a high voltage, and current continues to flows to the high-voltage side winding LH. Excitation voltage does not appear on the low-voltage side windings LL1 and LL2, and the terminals of the windings LL1 and LL2 are short-circuited. This starts the commutation operation of the transformer T.

After the commutation operation starts, the operation state shifts to switching state (7) as the MOS transistor Qr1 becomes active. Since the transformer T is still performing the commutation operation, electromotive force is not induced between the terminals of the low-voltage side windings LL1 and LL2. The output current that flows to the inductance element LO when the MOS transistors Qr1 and Qr2 are both active flows to both of the low-voltage side windings LL1 and LL2. Thereafter, the current path sequentially switches from the low-voltage side winding LL2 to the low-voltage side winding LL1. In this case, the current path is switched such that current continuously flows to the inductance element LO, which functions as an output coil.

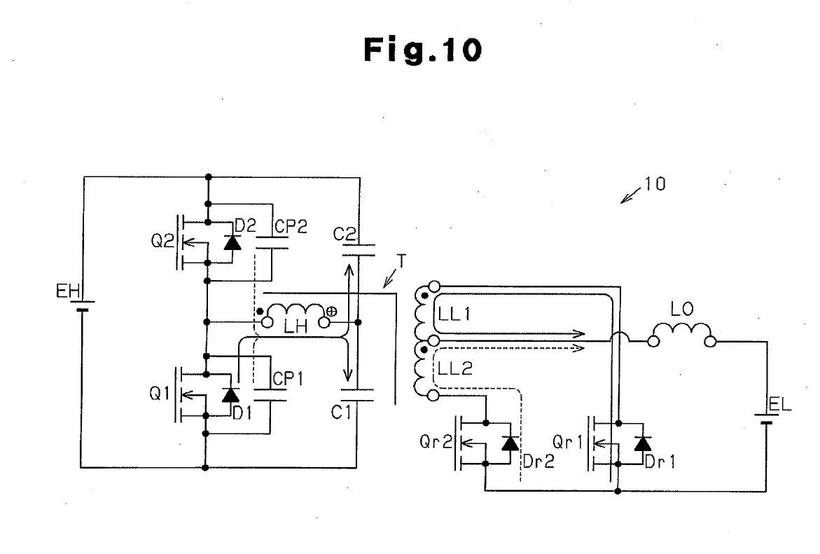

The operation state then shifts to switching state (8) shown in FIG. 10 and corresponding to switching state (4) (FIG. 6). Specifically, the MOS transistor Qr2 shifts to the inactive state as the commutation operation continues and current still flows to the low-voltage side winding LL2. After the MOS transistors Qr2 becomes inactive, current continuously flows via the antiparallel diode Dr2 of the MOS transistors Qr2. At about the same time, the voltage at the non-reference terminal of the high-voltage side winding LH becomes high, and current flows via the antiparallel diode D1 of the MOS transistors Q1.

The timing for shifting to the inactive state of the MOS transistor Qr2 is preferably the period during which the transistor T is performing the commutation operation. As long as the commutation operation is being performed, electromotive force is not induced between the terminals of the low-voltage side windings LL1 and LL2. Thus, excitation voltage is induced when the commutation operation is completed. However, if the MOS transistor Qr2 is in the active state in addition to the MOS transistor Qr1 after the commutation operation is completed, current may flow to the low voltage EL due to the excitation voltage since the terminals of the low-voltage side windings LL1 and LL2 are in a short-circuited state.

The shifting of the MOS transistor Qr1 to the active state and the shifting of the MOS transistor Qr2 to the inactive state may occur at the same time as long as the commutation operation is being performed. This is because the current flows via the antiparallel diodes Dr1 and Dr2 even if the MOS transistors Qr1 and Qr2 are inactive.

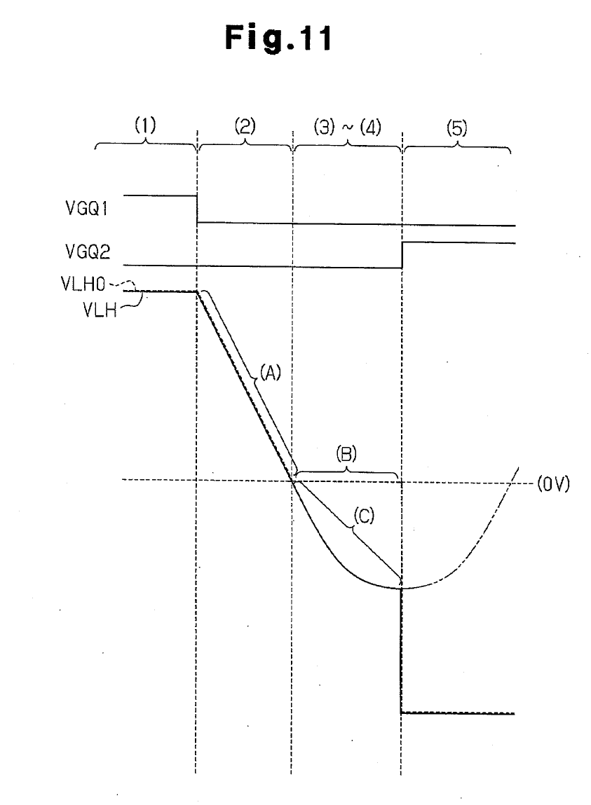

FIG. 11 is a timing chart showing in detail the operation during the dead time period in which the MOS transistors Q1 and Q2 are both inactive.

In switching state (1), the gate voltage VCQ1 is at high level and the gate voltage VCQ2 is at low level. Therefore, the MOS transistor Q1 is in the active state, and the MOS transistor Q2 is in the inactive state. In the high-voltage side winding LH, an inter-terminal voltage VLH (curve shown with sold line in FIG. 11) has a high voltage level when the potential of the non-reference terminal with respect to the reference terminal is positive. An inter-terminal voltage VLH0 (curve shown with dotted line in FIG. 11) corresponds to the excitation voltage of the transformer T.

When the gate voltage VGQ1 shifts to a low level and the MOS transistor Q1 shifts to the inactive state, the operation state becomes switching state (2). As a result, the inter-terminal voltages VLH, VLH0 of the high-voltage side winding LH decrease and eventually the inter-terminal voltages VLH, VLH0 of the high-voltage side winding LH related to the excitation voltage become 0 V ((A) in FIG. 11).

The operation then shifts to switching states (3) and (4). Excitation voltage is not applied to the transformer T ((B) in FIG. 11), and each inter-terminal voltage of the low-voltage side winding LL1 and LL2 becomes 0 V (not shown). The leakage inductance component exists on the high-voltage side winding LH. Thus, after the inter-terminal voltage VLH becomes 0V, the electromagnetic energy remaining in the leakage inductance component is discharged. The discharging destination is capacitors CP1 and CP2. Therefore, the LC resonance starts between the leakage inductance component and the capacitors CP1 and CP2 ((C) in FIG. 11). Due to the LC resonance, the inter-terminal voltage VLH becomes a negative voltage and reaches a minimum value, the gate voltage VGQ2 shifts to a high level and the MOS transistor Q2 becomes active.

When the inter-terminal voltage VLH reaches the minimum value, the potential at the reference terminal of the high-voltage side winding LH becomes maximum and the inter-terminal voltage between the drain and the source terminals of the MOS transistor Q2 becomes minimum. A soft switching operation may be performed by switching the MOS transistor Q2 at this point. The time from the start of LC resonance until the inter-terminal voltage VLH reaches the minimum value is known to be substantially one fourth the cycle of the LC resonance.

The total time of the period (A) in which the excitation voltage of the transformer decreases and the period (B) of substantially one fourth the cycle of the LC resonance performed between the leakage inductance component and the capacitors CP1 and CP2 by electromagnetic energy remaining in the leakage inductance component of the high-voltage side winding LH corresponds to the dead time of the MOS transistors Q1 and Q2. An asymmetric PWM operation is performed in the step-down operation while maintaining the dead time. Therefore, the dead time of the MOS transistors Q1 and Q2 is fixed to a predetermined time, and the shifting of the active state of the MOS transistors Q1 and Q2 may be performed by the soft switching operation.

In the step-down operation of the preferred embodiment, activation and inactivation of each MOS transistor Qr1 and Qr2 arranged on the low-voltage EL side of the transformer T is controlled in accordance with the active state of the MOS transistors Q1 and Q2 arranged at the high-voltage EH side of the transformer T. Thus, the MOS transistors Qr1 and Qr2 can function as synchronous rectification elements. The MOS transistors Qr1 and Qr2 output smoothed low-voltage EL by full-wave rectifying current at the low voltage EL side and continuously generating the output current that flows to the inductance element LO.

When the MOS transistors Qr1 and Qr2, which achieve a synchronous rectification function, is switched between the active state and the inactive state, the period in which both MOS transistors Qr1 and Qr2 are in the inactive state is not provided. Current constantly flows to the MOS transistor Qr1 or Qr2. However, current does not flow to the antiparallel diode Dr1 and Dr2. Therefore, the conduction loss of the low voltage EL is reduced.

The dead time period in which both MOS transistors Q1 and Q2 are in the inactive state is fixed to the time of (A) and (C) in FIG. 11 irrespective of the voltage conditions of the high voltage EH and the low voltage EL or other operation conditions. The soft switching control of the MOS transistors Q1 and Q2 is performed in such dead time period. In other words, the soft switching control is performed when asymmetric PWM controlling the MOS transistors Q1 and Q2 in the step-down operation. This reduces the switching loss of the MOS transistors Q1 and Q2.

Furthermore, the timing of switching the active state and the inactive state of each MOS transistor Qr1 and Qr2 is set within a period in which the transformer T performs the commutation operation in accordance with the shifting to the inactive state of the MOS transistors Q1 and Q2. The excitation voltage is not induced at the low-voltage side windings LL1 and LL2 during the commutation operation period of the transformer T. Thus, unnecessary current does not flow to the terminals of the windings LL1 and LL2 even if the terminals of the low-voltage side windings LL1 and LL2 become short-circuited in the period in which the MOS transistors Qr1 and Qr2 are both in the activation state when switching to the activate state and the inactive state of each MOS transistor Qr1 and Qr2. Therefore, the switching of the current path between the low-voltage side windings LL1 and LL2 is smoothly carried out.

The timing for shifting the MOS transistors Qr1 and Qr2 to the inactive state is set, at the latest, to the timing the transformer T completes the commutation operation in accordance with the shifting of the MOS transistors Q1 and Q2 to the inactive state. Thus, the period in which MOS transistors Qr1 and Qr2 are both in the active state is within a period during which the transformer T performs the commutation operation. That is, the voltage is not induced between the terminals of the low-voltage side windings LL1 and LL2 when the MOS transistors Qr1 and Qr2 are both active and the terminals of the low-voltage side windings LL1 and LL2 are short-circuited. Accordingly, unnecessary current does not flow.

The dead time period during which the MOS transistors Q1 and Q2 are both in the inactive state is the time from when the MOS transistors Q1 and Q2 shift to the inactive state until when the voltage between the drain and the source terminals of the MOS transistors Q1 and Q2 becomes minimum, due to the LC resonance of the leakage inductance of the high-voltage side winding LH, and the capacitors CP1 and CP2 becomes minimum in the commutation operation of the transformer T. Thus the energy stored in the leakage inductance in the high-voltage side winding LH is LC resonated between the leakage inductance and the capacitors CP1 and CP2. Then, the MOS transistors Q1 and Q2 is shifted to the active state. Therefore, the MOS transistors Q1 and Q2 may be controlled by the soft switching operation.

If the dead time of the MOS transistors Q1 and Q2 is divided substantially by one half into the resolving period of the excitation voltage of the transformer T and the commutation period resulting from the LC resonance of the leakage inductance and the capacitors CP1 and CP2, the timing for switching the MOS transistor Q1 and Q2 between the active state and the inactive state is set to a timing that is substantially in the middle of the dead time of the MOS transistors Q1 and Q2.

The step-up operation will now be described with reference to FIGS. 12 to 15. FIG. 12 shows switching states (8), (1), and (2). The MOS transistor Qr1 becomes active, and current flows through a path extending from the low voltage EL to the ground potential through the inductance element LO, the low-voltage side winding LL1, and the MOS transistor Qr1. The transformer T is excited and high voltage is induced at the non-reference terminal of the high-voltage side winding LH. If the MOS transistor Q1 is active at this point, the MOS transistor Q1 functions as the synchronous rectification element, and the capacitor C1 is charged through the high-voltage side winding LH (switching state (1)). If the MOS transistor Q1 is inactive, the capacitor C1 is charged through the high-voltage side winding LH by the antiparallel diode D1 (switching state (2)).

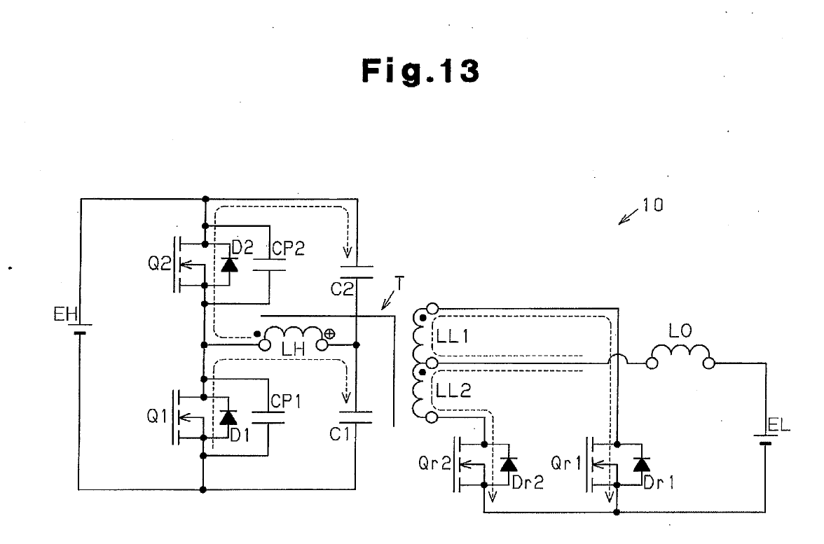

FIG. 13 shows switching states (3) and (4). The MOS transistors Qr2 becomes active, and at the same time or after a period in which the MOS transistors Qr1 and Qr2 both become active states, the MOS transistor Qr1 shifts to the inactive state.

If the MOS transistors Qr1 and Qr2 are both in an active state (switching state (3)), the terminals of the low-voltage side windings LL1 and LL2 are in a short-circuit state. Since there is no application of excitation voltage to the transformer T, electromotive force is not induced between the terminals of the high-voltage side winding LH. Therefore, the current of switching state (2) (FIG. 12) continues to flow. That is, the current continues to flow from the antiparallel diode D1 to the capacitor C1 through the high-voltage side winding LH.

When the MOS transistor Qr1 shifts to the inactive state (switching state (4)), the current flowing to the inductance element LO continuously flows from the low-voltage side winding LL1 to the low-voltage side winding LL2 at the low voltage EL side. This reverses the excitation direction of the transformer T, and the reference terminal of the high-voltage side winding LH becomes high voltage. Therefore, current flows in a direction for charging the capacitor C2 through the antiparallel diode D2 of the MOS transistor Q2.

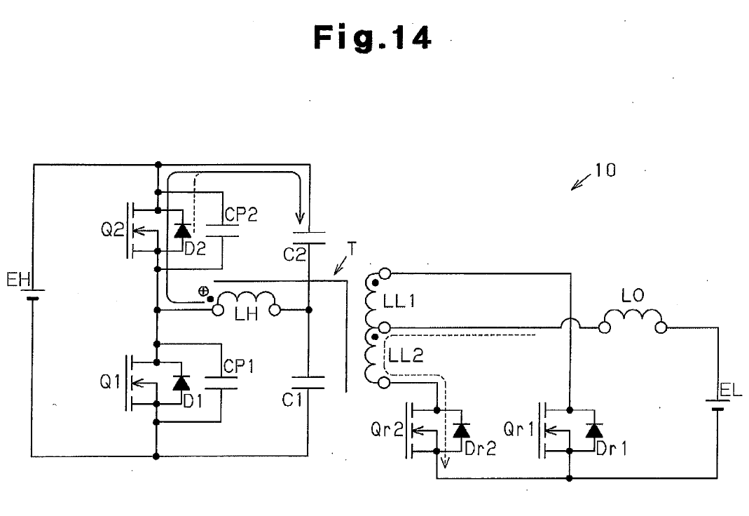

FIG. 14 shows switching states (5) and (6). The MOS transistor Qr2 is active and current flows through a path extending from the low voltage EL to the ground potential through the inductance element LO, the low-voltage side winding LL2 and the MOS transistor Qr2. High voltage is induced at the reference terminal of the high-voltage side winding LH by the excitation of the transformer T. If the MOS transistor Q2 is active at this point, the MOS transistor Q2 functions as a synchronous rectification element and the capacitor C2 is charged through the high-voltage side winding LH (switching state (5)). If the MOS transistor Q2 is inactive, the capacitor C2 is charged through the high-voltage side winding LH by the antiparallel diode D2 (switching state (6)).

The timing of switching state (5) at which the MOS transistor Q2 shifts to the active state must be at least after the recovery time of the diode D1 elapses from when inverse bias is applied to the antiparallel diode D1 of the MOS transistor Q1 in the immediately previous switching state (4). This is because through current flows from the MOS transistor Q2 through the antiparallel diode D1 if the MOS transistor Q2 shifts to the active state before the recovery time elapses.

Specifically, the time from when the MOS transistor Qr1 shifts to the inactive state (switching state (3) and (4)) to the timing the MOS transistor Q2 shifts to the active state (switching state (5)) is preferably longer than or equal to the recovery time of the antiparallel diode D1.

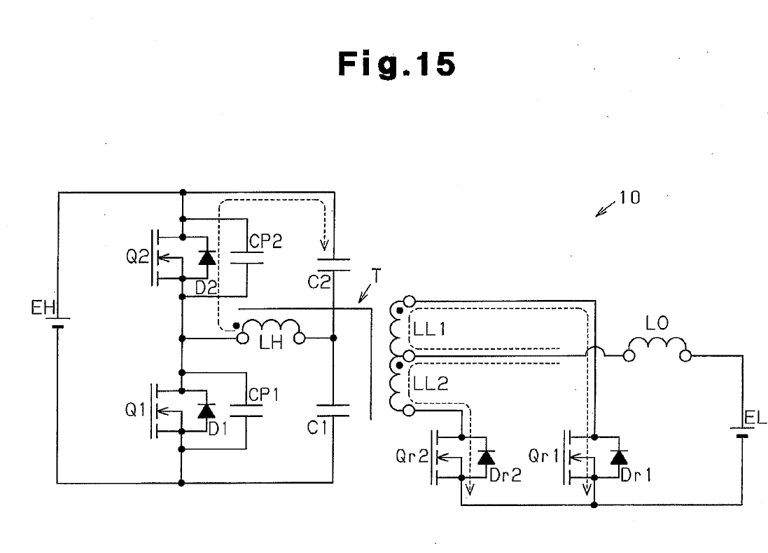

FIG. 15 shows switching states (7) and (8), which are similar to the operation states of switching states (3) and (4) shown in FIG. 13. The MOS transistors Qr1 becomes inactive. At the same time or after a period in which both MOS transistors Qr1 and Qr2 become active states, the MOS transistor Qr2 shifts to the inactive state.

If the MOS transistors Qr1 and Qr2 are both in the active state (switching state (7)), the terminals of the low-voltage side windings LL1 and LL2 are in a short-circuit state. Since there is no application of excitation voltage to the transformer T, electromotive force is not induced between the terminals of the high-voltage side winding LH. Therefore, the current of switching state (6) (FIG. 14) continues to flow. That is, the current continues to flow to the capacitor C2 through the antiparallel diode D2.

When the MOS transistor Qr2 shifts to the inactive state (switching state (8)), the current flowing to the inductance element LO continuously shifts from the low-voltage side winding LL2 to the low-voltage side winding LL1 on the low voltage EL side. This reverses the excitation direction of the transformer T, and the voltage at the non-reference terminal of the high-voltage side winding LH becomes high. Therefore, the current flows in the direction for charging the capacitor C1 through the antiparallel diode D1 of the MOS transistor Q1 (state similar to FIG. 12).

In the step-up operation of the preferred embodiment, a period in which the MOS transistors Qr1 and Qr2 both become inactive states is not provided when the MOS transistors Qr1 and Qr2 are shifted from the active states. Thus, voltage is continuously applied to the low-voltage side windings LL1 and LL2 of the transformer T. Therefore, the generation of surge voltage is suppressed, and voltage of inverse bias is stably and alternately applied. The voltage applied to the low-voltage side windings LL1 and LL2 is generated by a continuous path current flowing to the inductance element LO and increased from the low voltage EL.

The time from when the MOS transistor Qr2 shifts to the inactive state to when the MOS transistor Q1 shifts to the active state is set to at least the recovery time of the antiparallel diode D2 of the MOS transistor Q2. The time from when the MOS transistor Qr1 shifts to the inactive state to when the MOS transistor Q2 shifts to the active state is set to at least the recovery time of the antiparallel diode D1 of the MOS transistor Q1. Therefore, through current does not flow through the MOS transistors Q1 and Q2, which are shifted to the active state, and the antiparallel diodes D1 and D2.

The step-down operation in which power is transmitted from the high voltage EH to the low voltage EL via the transformer T and the step-up operation in which power is transmitted from the low voltage EL to the high voltage EH via the transformer T are both performed at the timings of switching control shown in FIG. 2 for the MOS transistors Q1, Q2, Qr1 and Qr2. Since the control for each direction of the bidirectional DC-DC converter is the same, the control is simplified.

The MOS transistors Q1, Q2, Qr1, and Qr2 are examples of first to fourth switch elements, and capacitors CP1 and CP2 are examples of first and second capacitors.

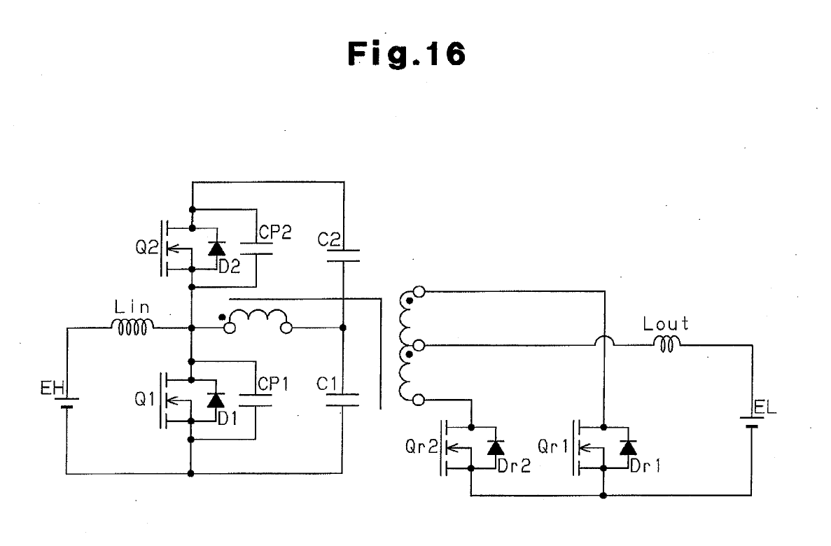

FIGS. 16 to 18 are diagrams of further circuits to which the switching timing shown in FIG. 2, that is, the method for controlling the bidirectional DC-DC converter according to the present invention can be applied.

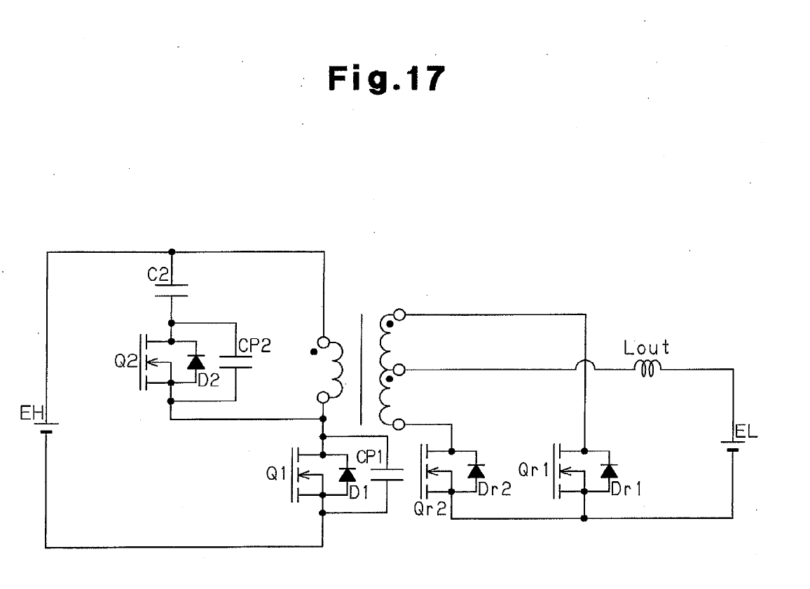

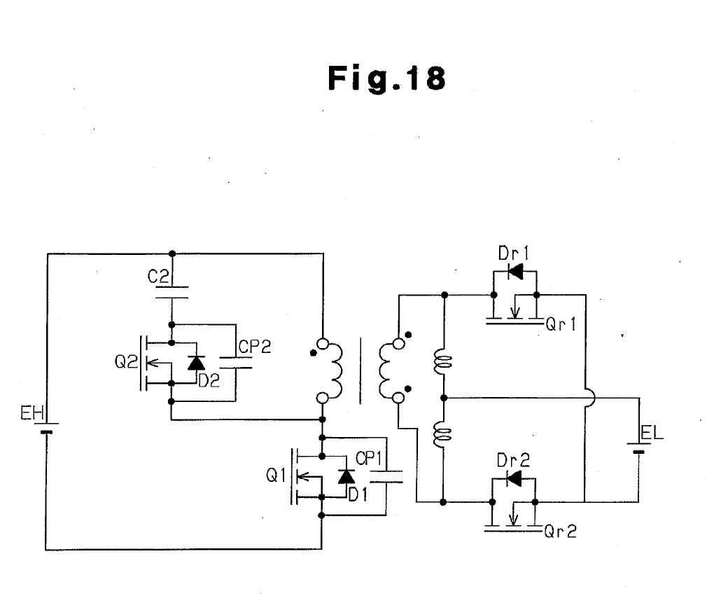

FIG. 16 is a boost half bridge circuit, FIG. 17 is an active clamp forward circuit, and FIG. 18 is a circuit in which a current doubler rectification circuit is added to the active clamp forward circuit. In each of the circuits, elements having the same effect and function as those in the circuit of FIG. 1 are denoted with the same reference numerals.

As described above in detail, the method for controlling the bidirectional DC-DC converter in the preferred embodiment controls the step-down operation and the step-up operation at the same switching control timing. This simplifies the control.

In the step-down operation, the dead time is fixed to a predetermined time by executing the asymmetric PWM control on the MOS transistors Q1 and Q2 on the high voltage EH side. Thus, the soft switching operation can be performed on the MOS transistors Q1 and Q2, and switching loss is reduced.

Furthermore, a period in which the MOS transistors Qr1 and Qr2 on the low voltage EL side are both in the inactive state does not exist for the MOS transistors Qr1 and Qr2. Thus, when the MOS transistors Qr1 and Qr2 perform synchronous rectification operation in the step-down operation, the period in which the current flows to the antiparallel diodes Dr1 and Dr2 becomes short. This reduces the conduction loss.

In the step-up operation, at least one of the MOS transistors Qr1 and Qr2 is maintained in the active state. Thus, the current flowing from the inductance element LO to the low-voltage side winding LL1 and LL2 does not become discontinuous. This prevents the generation of surge voltage when shifting from active states.

It should be apparent to those skilled in the art that the present invention may be embodied in many other specific forms without departing from the spirit or scope of the invention. Particularly, it should be understood that the present invention may be embodied in the following forms.

The MOS transistors Qr1 and Qr2 respectively include the antiparallel diodes Dr1 and Dr2 in the preferred embodiment. However, the antiparallel diodes Dr1 and Dr2 may be omitted. That is, in the present invention, there is no period during which the MOS transistors Qr1 and Qr2 are both in the inactive state. Thus, the antiparallel diodes Dr1 and Dr2 are not necessarily required.

The present examples and embodiments are to be considered as illustrative and not restrictive, and the invention is not to be limited to the details given herein, but may be modified within the scope and equivalence of the appended claims.

What is claimed:

1. A method for controlling a bidirectional DC-DC converter for selectively performing a step-down operation and a step-up operation, wherein the bidirectional DC-DC converter includes a transformer, which has a high-voltage side winding and a low-voltage side winding, alternately activated first and second switch elements connected to the high-voltage side winding for alternately applying high voltage in opposite directions to the high-voltage side winding during the step-down operation and full-wave rectifying current that is output from the high-voltage side winding by performing synchronous rectification during the step-up operation, first and second antiparallel diodes respectively connected to the first and second switch elements, first and second capacitors respectively connected in parallel to the first and second switch elements, third and fourth switch elements connected to the low-voltage side winding and activated in accordance with the active state of the first and second switch elements for full-wave rectifying current that is output from the low-voltage side winding by performing synchronous rectification during the step-down operation and alternately applying low voltage in opposite directions to the low-voltage side winding during the step-up operation, third and fourth antiparallel diodes respectively connected to the third and fourth switch elements, and an inductance element arranged in a path extending from the low-voltage side winding to the low voltage, the method comprising:
activating the third switch element;
activating the first switch element when the third switch element is in an active state;
activating the fourth switch element;
activating the second switch element when the fourth switch element is in an active state; and
switching each of the third and fourth switch elements between an active state and an inactive state while inactivating the first and second switch elements for a predetermined time and activating at least one of the third and the fourth switch elements.

2. The method according to claim 1, wherein said switching includes setting a timing for switching the active state and the inactive state of each of the third and fourth switch elements during the step-down operation within a period the transformer performs a commutation operation in accordance with shifting of each of the first and second switch elements to the inactive state.

3. The method according to claim 1, wherein said switching includes:
setting a timing for shifting the third switch element to the inactive state during the step-down operation to, at the latest, a timing at which the transformer completes a commutation operation in accordance with shifting of the first switch element to the inactive state; and
setting a timing for shifting the fourth switch element to the inactive state during the step-down operation to, at the latest, a timing at which the transformer completes the commutation operation in accordance with shifting of the second switch element to the inactive state.

4. The method according to claim 1, wherein said switching includes:
setting a time from a timing at which the fourth switch element is shifted to the inactive state to a timing at which the first switch element is shifted to the active state to at least a recovery time of the second antiparallel diode of the second switch element; and
setting a time from a timing at which the third switch element is shifted to the inactive state to a timing at which the second switch element is shifted to the active state to at least a recovery time of the first antiparallel diode of the first switch element.

5. The method according to claim 1, wherein said switching includes setting the predetermined time to a fixed time.

6. The method according to claim 1, wherein said switching includes setting the predetermined time to a time obtained by adding a time in which excitation voltage applied to the transformer decreases and a time in which the transformer performs a commutation operation.

7. The method according to claim 1, wherein:
the transformer performs a commutation operation in accordance with shifting of each of the first and second switch elements to the inactive state, each of the first and second switch elements including first and second terminals determining an inter-terminal voltage, and the inter-terminal voltage of each of the first and the second switch elements in the step-down operation being minimized by a LC resonance occurring due to the first and second capacitors and a leakage inductance generated at the high-voltage side winding by the commutation operation of the transformer; and
said switching includes:
setting the predetermined time to a first time from when the first switch element is shifted to the active state during the step-down operation until when the inter-terminal voltage of the first switch element is minimized by the LC resonance; and
setting the predetermined time to a second time from when the second switch element is shifted to the inactive state during the step-down operation until when the inter-terminal voltage of the second switch element is minimized by the LC resonance.

8. The method according to claim 7, wherein:
the high-voltage side winding includes a reference terminal and a non-reference terminal determining the inter-terminal voltage;
said switching includes:
setting the predetermined time to a time obtained by adding a time from when the first and second switch elements are each shifted to the inactive state during the step-down operation until when the inter-terminal voltage at the high-voltage side winding becomes substantially zero and a time that is one fourth an LC resonance cycle.

9. The method according to claim 7, wherein said switching includes setting a timing for switching the active state and the inactive state of each of the third and forth switch elements to a timing that is at substantially the middle of the predetermined time.
